(19) United States
(12) Patent Application Publication
(10) Pub. No.: US 2011/0270843 A1
(43) Pub. Date: Nov. 3, 2011

(54) SPECIALIZED SEARCH ENGINES

(75) Inventor: Scott M. Albin, Great Neck, NY (US)

(73) Assignee: Mayo Foundation for Medical Education and Research, Rochester, MN (US)

(21) Appl. No.: 12/938,945

(22) Filed: Nov. 3, 2010

Related U.S. Application Data
(60) Provisional application No. 61/258,681, filed on Nov. 6, 2009.

(51) Int. Cl. G06F 17/30

(52) U.S. Cl. 707/741; 707/769; 707/E17.002; 707/E17.014

(57) ABSTRACT

A specialized search engine tool designed for subject matter experts facilitates access to information relevant to their area of expertise available on public domains over the Internet. The specialized search engine represents the collection of thousands of links that are sorted, resorted, categorized and placed into databases that interact with one another. The specialized search engine may permit a user to compare results from multiple databases and automatically submit their search query to many popular searchable databases and web sites from a central web page, without having to individually visit each site. In one example, the specialized search engine is a medical search engine.

### TECHNICAL FIELD

The disclosure relates generally to computerized techniques for searching media using a data communications network, such as the Internet.

### BACKGROUND

The World Wide Web (or “Web”) is a system of interlinked hypertext documents (e.g., web pages) stored on an array of private and public computer networks and accessed via a global data communications system, such as the Internet. A web site is a collection of related web pages, images, videos or other digital information. Hyperlinks (embedded shortcuts or links to other web pages) allow users to quickly navigate between pages of the Web in their attempt to locate information of interest.

Computerized search engines, such as Google™, Bing™, Yahoo!®, Search, etc., are tools designed to sort through the large quantity of information accessible via the network. A user types a query relating to their desired topic into the search engine. The search results, or “hits,” are then presented on the user's computer screen as some kind of list. The search results may consist of web pages, images, video, multimedia and other types of electronic information. The list of hits may include a hyperlink (shortcut) to the associated URL (the web address or location on the internet where the resource can be found) and a short characterization of the information contained in the resource.

Search engines commonly use text-based searching to determine relevant web pages. Text-based searching seeks to find web pages that include the terms of the user's search query. To determine the relative ranking of the resultant hits, search engines may consider additional factors, such as the number of times the search terms appear, proximity of search terms to each other, meta elements (keywords, description, etc.), links to other pages, the number of times a particular page is linked to by other web pages, etc.

Due to the sheer volume of information on the Web, ensuring that the returned pages align well with the user's desired topic is a central problem in Web searching.

### SUMMARY

The present disclosure relates generally to specialized search engine tool(s) that facilitate access to information relevant to a particular area of expertise available on public domains over the Internet. In one example, the specialized search engine tool(s) may be designed for subject matter experts and may facilitate access to information relevant to their area of expertise available on public domains over the Internet. In addition, the techniques set forth herein may also be applied to any subject matter area in which a specialized search engine may be useful or desirable. The specialized search engine may represent the collection of thousands of links that are sorted, resorted, categorized and placed into databases that interact with one another. In one example, the specialized search engine may permit a user to compare results from multiple databases and automatically submit their search query to many popular searchable databases and web sites from a central web page, without having to individually visit each site.

In one example, the disclosure is directed to a computer-implemented method comprising choosing web pages relevant to an area of expertise, identifying search terms relevant to the area of expertise contained in each of the chosen web pages, identifying a plurality of topics relevant to the area of expertise, identifying a plurality of themes relevant to the area of expertise, associating each of the identified topics with one of the identified themes and creating topic indexes of identified search terms and associated web pages, each associated with a different one of the identified topics, based on relevance of the search terms and the web pages to the topic. The computer-implemented method may also include receiving input from a user via a remote device that identifies a first one of the themes and a first one of the topics in which a search is to be performed, receiving a search query from the user via the remote device, generating a first set of search results for the search query based on the topic index associated with the first topic and transmitting search results to the remote device. The computer-implemented method may also include receiving input from the user via the remote device that identifies a second one of the topics in which a search is to be performed and generating a second set of search results for the search query based on the topic index associated with the second topic. The computer-implemented method may also include receiving input from the user via the remote device that identifies a second one of the themes in which a search is to be performed and generating a second set of search results for the search query based on the topic indexes associated with each of the topics associated with the second theme.

In another example, the disclosure is directed to system including at least one topic database that stores a plurality of topic indexes each associated with one of plurality of topics relevant to an area of expertise, each topic index including a plurality of search terms and associated lists of web pages relevant to the area of expertise and relevant to the topic that contain the search terms, and a processor configured to receive input from a user via a remote device that identifies one of the plurality of topics in which a search is to be performed, receive a search query from the user via the remote device, and generate a set of search results for the search query based on the topic index associated with the identified topic. The processor may be further configured to transmit the search results to the remote device.

The details of one or more examples are set forth in the accompanying drawings and the description below. Other features and/or advantages will be apparent from the description and drawings, and from the claims.

### BRIEF DESCRIPTION OF DRAWINGS

FIGS. 1-12 are diagrams of example user interfaces that may be presented by a specialized medical search engine.

FIG. 13 is a block diagram illustrating an example medical search engine communicatively coupled with a user via a network.

FIG. 14 is a block diagram illustrating an example conceptual arrangement of topic search engine modules.

FIG. 15 is a block diagram illustrating an example conceptual arrangement of topic indexes.

FIGS. 16-24 are diagrams of example user interfaces that may be presented by the medical search engine in response to input by a user.

FIGS. 25-26 are flowcharts illustrating exemplary operation of a specialized search engine.

### DETAILED DESCRIPTION

The present disclosure relates generally to specialized search engine tool(s) that facilitate access to information relevant to a particular area of expertise available on public domains over the Internet. In one example, the specialized search engine tool(s) may be designed for subject matter experts and may facilitate access to information relevant to their area of expertise available on public domains over the Internet. The specialized search engine represents the collection of thousands of links that are sorted, resorted, categorized and placed into databases that interact with one another. In one example, the specialized search engine may permit a user to compare results from multiple databases and automatically submit their search query to many popular searchable databases and web sites from a central web page, without having to individually visit each site.

In one example that will be described in detail herein, a specialized search engine is designed for medical clinicians (physicians, physician assistants, nurses, researchers, etc.) and facilitates access to medical information available on public domains over the Internet. However, it shall be understood that the techniques set forth herein may also be applied to other areas of expertise and/or directed toward subject matter experts in other areas of expertise. In addition, the techniques set forth herein may also be applied to any subject matter area in which a specialized search engine may be useful or desirable.

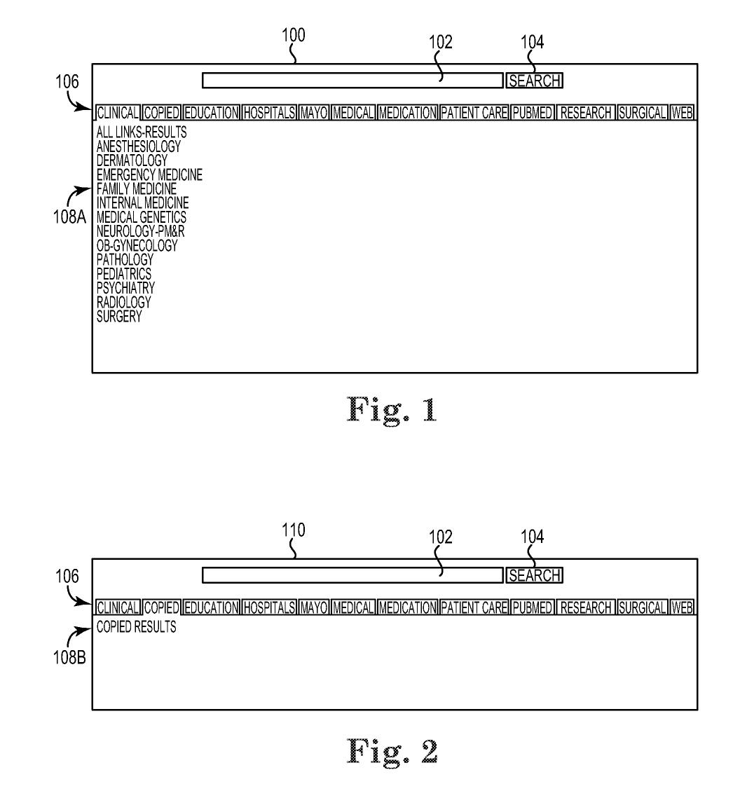

FIGS. 1-12 are diagrams of example user interfaces that may be presented by an example specialized medical search engine. FIGS. 1-12 illustrate the overall organization of the example medical search engine and relationships between the various components thereof. Referring to FIG. 1, for example, an example web page 100 includes a search box 102 into which a user enters a search query and a search button 104 which, when clicked (or otherwise interacted with) by a user, causes the search engine to perform a search based on the query. A series of tabs 106 are each associated with a different medically related “theme.” Each theme tab 106 is associated with a different topic list 108.

For specialized search engines directed to other areas of expertise or other subject matter areas, web page 100 would be adapted to be relevant to that particular area. For example, the number and nomenclature of tabs 106 may change so as to be relevant to the particular subject matter area. Similarly, the number and nomenclature of topics in the topic list 108 may also change to suit the subject matter area at issue.

In FIG. 1, for example, a user has clicked on the “Clinical” tab in web page 100 of the example medical search engine. This causes a topic list 108A to be displayed. In this example, topic list 108A under the Clinical tab corresponds to a real world organizational structure commonly found in hospitals, clinics, or other healthcare facilities. That is, the topics under the Clinical tab correspond to identified departments and specialties within the medical profession. In this example, the Clinical tab is associated with a topic list 108A including the topics All Links -Results, Anesthesiology, Dermatology, Emergency Medicine, Family Medicine, Internal Medicine, Medical Genetics, Neurology-PM&R, Ob-Gynecology, Pathology, Pediatrics, Psychiatry, Radiology, and Surgery. The topic “All Links-Results” permits a user to search all of the topics in the topic list 108C simultaneously.

It shall be understood that certain themes, topic lists and topics are presented herein as examples of those themes, topics and topics lists that may be included along with the example search engine(s) described herein, and that more, fewer, or different themes, topics and topic lists may also be included without departing from the scope of the present disclosure.

In FIG. 2, a user has clicked on the “Copied” tab. This causes a topic list 108B to be displayed. The Copied tab is a section which may act as clipboard for links that have been posted to it when a user clicks on the “copy” button found below each link on the other tabs. This allows a user to collate a collection of links. This display area could also be used to save searches to a user profile stored on a server that is accessed by login to a personalized account.

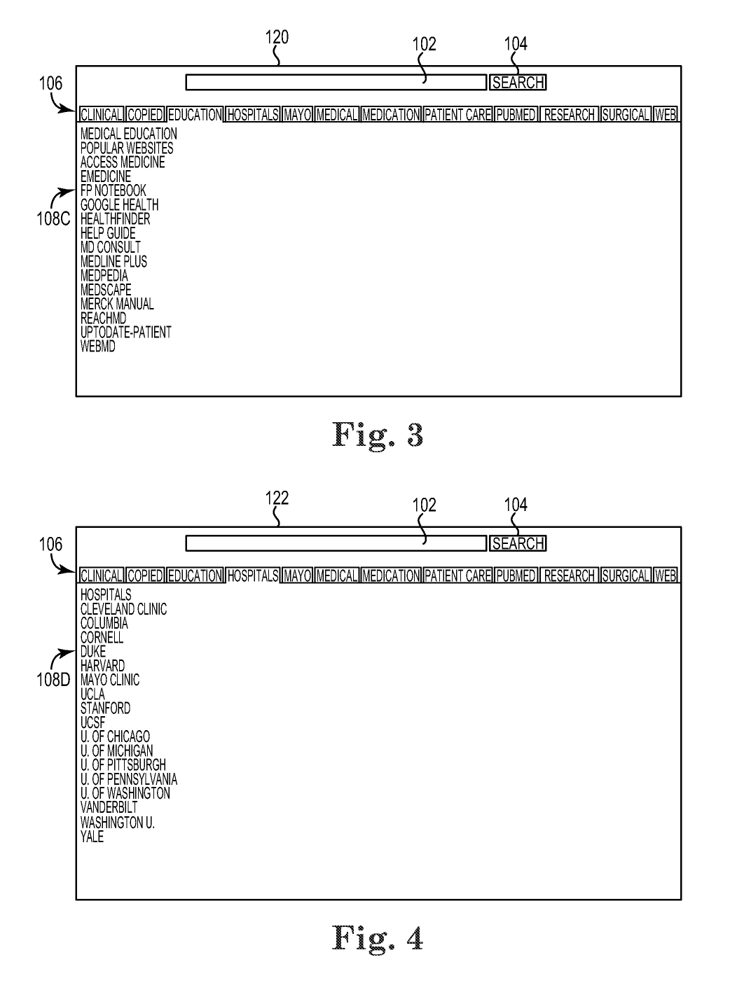

In FIG. 3, a user has clicked on the “Education” tab. This causes a topic list 108C to be displayed. The topic list under the Education tab corresponds to a selected list of medically reputable websites relating to patient education. For example, the example topic list 108C includes the websites Access Medicine, EMedicine, FP Notebook, Google Health, HealthFinder, Help Guide, MD Consult, Medline Plus, MedPedia, MedScape, Merck Manual, ReachMD, UptoDate Patient and WebMD. The topic “Popular Websites” permits a user to search all of the topics in the topic list 108C simultaneously.

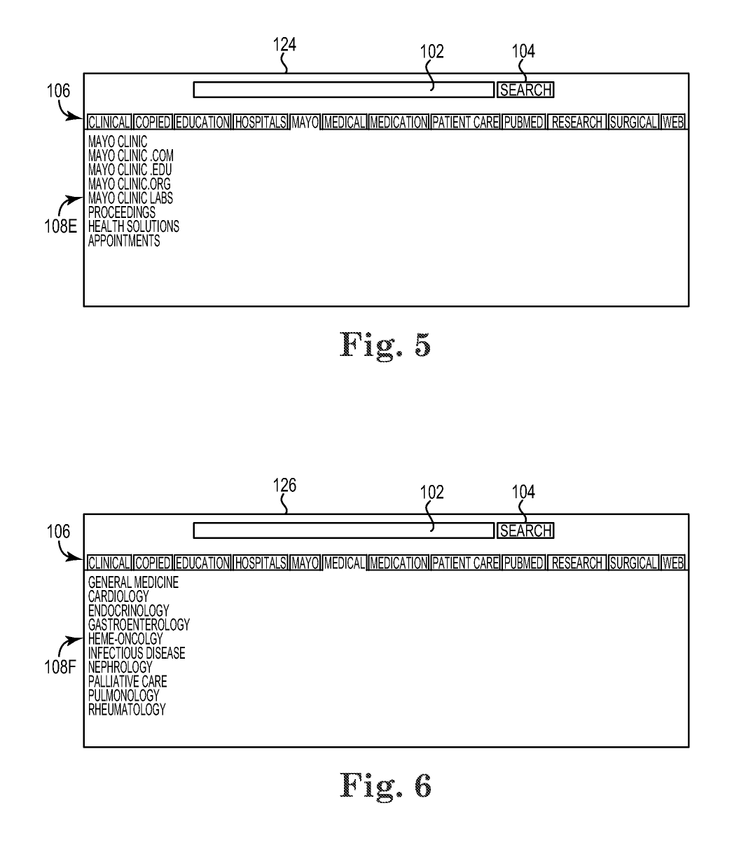

In FIG. 4, a user has clicked on the “Hospitals” tab. This causes a topic list 108D to be displayed. The topic list under the Hospitals tab corresponds to a selected list of top hospitals and University research hospitals in the United States. The example topic list 108D includes the topics Cleveland Clinic, Columbia, Cornell, Duke, Harvard, Mayo Clinic, UCLA Stanford, UCSF, University of Chicago, University of Michigan, University of Pennsylvania, University of Washington, Vanderbilt, Washington University, and Yale. Other topics may also be included. The topic “Hospitals” permits a user to search all of the topics in the topic list 108D simultaneously.

In FIG. 5, a user has clicked on the “Mayo” tab. This causes a topic list 108E to be displayed. The topic list under the Mayo tab corresponds to selected websites administered by the Mayo Clinic. The example topic list 108E includes the topics MayoClinic.com, Mayo Clinic.edu, Mayo Clinic.org, Mayo Clinic Labs, Proceedings, and Appointments. The topic “Mayo Clinic” permits a user to search all of the topics in the topic list 108E simultaneously.

In FIG. 6, a user has clicked on the “Medical” tab. This causes a topic list 108F to be displayed. The topic list under the Medical tab corresponds to selected recognized specialties within the medical profession. In this example, topic list 108F includes the topics General Medicine, Cardiology, Endocrinology, Gastroenterology, Heme-oncology, Infectious Disease, Nephrology, Palliative Care, Pulmonology and Rheumatology. Other specialties or areas of medicine may also be included. The topic “General Medicine” permits a user to search all of the topics in the topic list 108F simultaneously.

In FIG. 7, a user has clicked on the “Medication” tab. This causes a topic list 108G to be displayed. The topic list 108G under the Medication tab corresponds to a selected list of medically reputable websites relating to medications. For example, the example topic list 108G includes the websites Antibiotic Guide, DoublecheckMD, Drugs.com, FDA, Fingertip Formulary, Global Pharm, ISMP, Medscape Drugs, MPR, Pharmogenomics, Pharm Journal and RXList.com. Other websites relating to medications may also be included. The topic “Medications” permits a user to search all of the topics in the topic list 108G simultaneously.

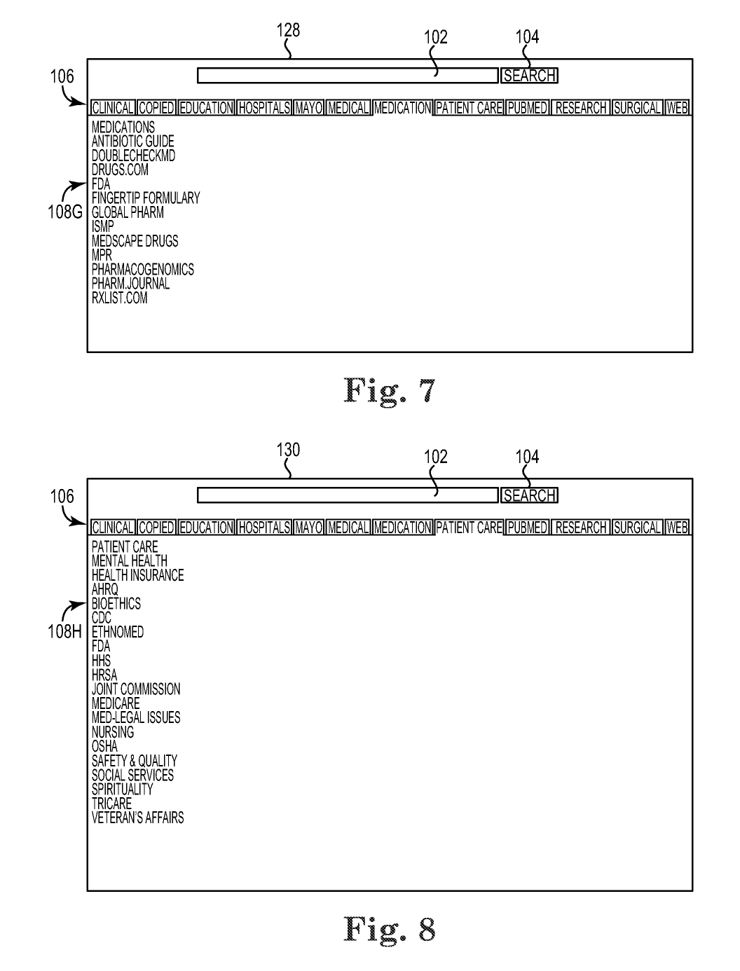

In FIG. 8, a user has clicked on the “Patient Care” tab. This causes a topic list 108H to be displayed. Some of the topics in the topic list 108H under the Patient Care tab correspond to a selected list of medically reputable websites relating to patient care, such as AHRQ, CDC, FDA, HHS, HRSA, the Joint Commission, Medicare, OSHA, Tricare and Veteran's Affairs. Other of the topics in topic list 108H correspond to selected topical subject matter relating to patient care, such as Mental Health, Health Insurance, Bioethics, Med-Legal Issues, Nursing, Safety and Quality, Social Services and Spirituality. Other topics related to patient care may also be included. The topic “Patient Care” permits a user to search all of the topics in the topic list 108H simultaneously.

In FIG. 9, a user has clicked on the “PubMed” tab. This causes a topic list 108I to be displayed. The topic list 108G under the PubMed tab includes the topic PubMed, which permits a user to search the PubMed website.

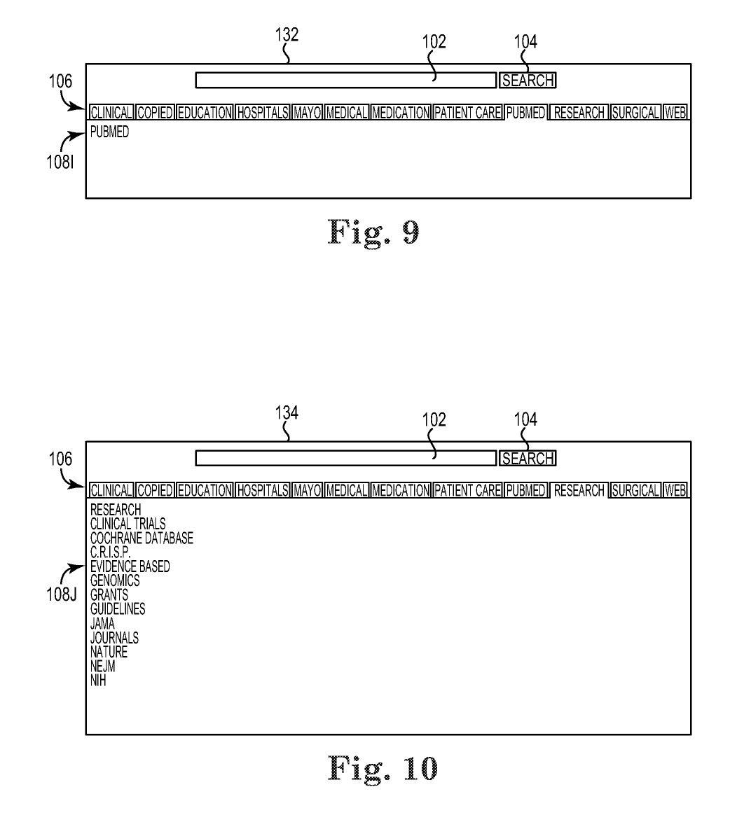

In FIG. 10, a user has clicked on the “Research” tab. This causes a topic list 108J to be displayed. Some of the topics in topic list 108G tab correspond to a selected list of medically reputable websites relating to medical research, such as the Cochrane Database, Clinical Trials, CRISP, Guidelines, JAMA, Nature, JEJM and HIH. Other of the topics in topic list 108J correspond to defined spheres relating to medical research, such as Evidence Based, Genomics, Grants and Journals. Other websites relating to medical research may also be included. The topic “Research” permits a user to search all of the topics in the topic list 108J simultaneously.

In FIG. 11, a user has clicked on the “Surgical” tab. This causes a topic list 108K to be displayed. The topics in topic list 108K correspond to identified sub-specialties within the surgical field, such as Cardiothoracic surgery, Ophthalmology, Oral and Maxillofacial surgery, Orthopedic surgery, Otolaryngology, Plastic Surgery, Surgical Education and Urology. Other specialties or sub-specialties may also be included. The topic “Surgery” permits a user to search all of the topics in the topic list 108K simultaneously.

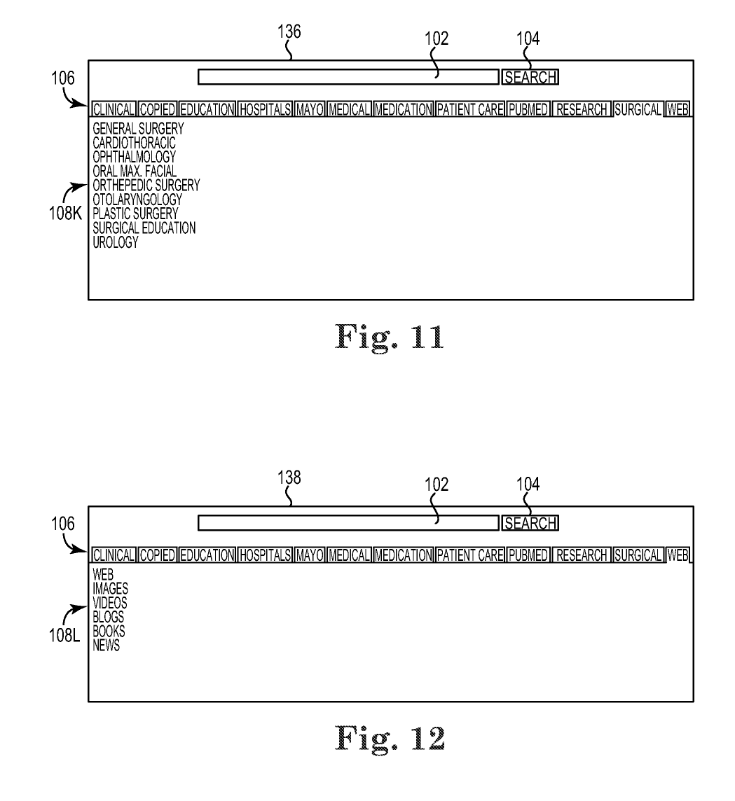

In FIG. 12, a user has clicked on the “Web” tab. This causes a topic list 108L to be displayed. The topics in topic list 108L corresponds to a search of the entire World Wide Web. For example, the topics in topic list 108L correspond to a selected list of common types of media available on the Web, including Images, Videos, Blogs, Books and News. Other types of media or searches may also be included. The topic “Web” permits a user to search all of the topics in the topic list 108L simultaneously.

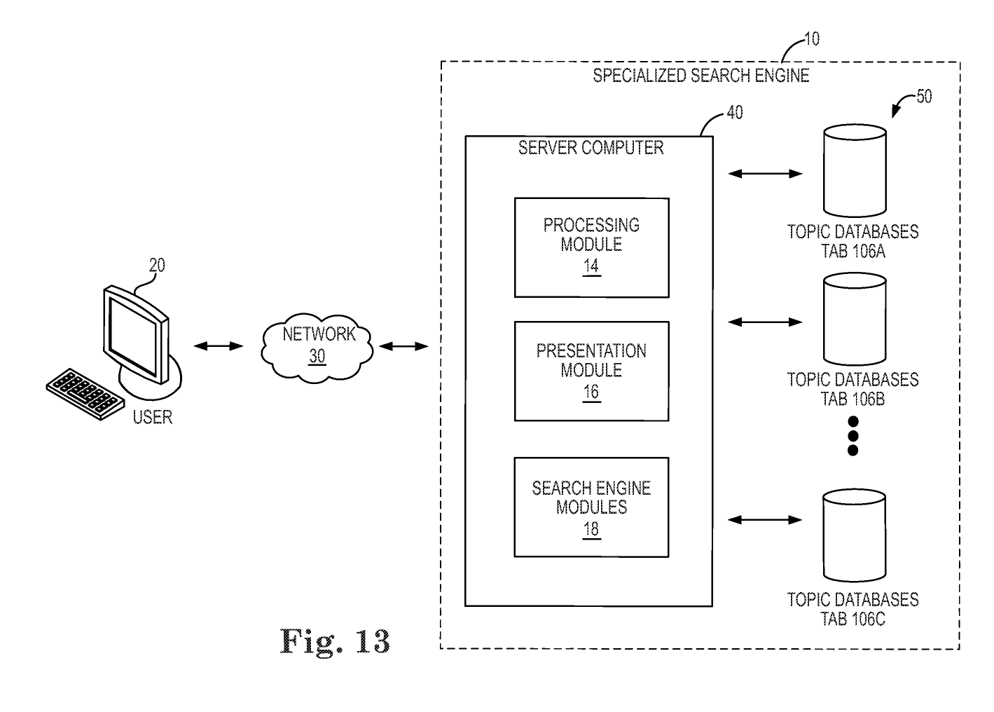

FIG. 13 is a block diagram illustrating an example specialized search engine 10 communitively coupled with a user computer 20 via a network 30. Specialized search engine 10 includes a server computer 40 and topic databases 50. Server 40 includes a processing module 14, a presentation module 16 and search engine modules 18. Topic databases 50 include individual topic databases for each of tabs 106A-N. In one example, specialized search engine 10 is a medical search engine. Specialized search engine 10 may also correspond to any other area of expertise or subject matter area in which a specialized search engine may be useful or desirable.

Processing module 14 includes the processing hardware that executes searches based on search queries entered into the specialized search engine by a user via user computer 20. Presentation module 16 dictates the visual presentation of the search engine and the search results on user computer 20. For example, presentation module 16 dictates the visual presentation of the user interfaces shown in FIGS. 1-12 and 16-24.

Search engine modules 18 include individual topic search engine modules for each of the topics in topic lists 108. Topic databases 50 include individual topic indexes for each of the topics contained in topic lists 108 under each theme tab 106. In the case of a medical search engine, each topic index contains a list of clinically relevant diagnostic terms associated with the topic. The diagnostic terms may include terms relevant to, for example, disorders, diseases, conditions, diagnosis, treatment, pharmaceuticals, symptoms, procedures, area of practice, specialties, etc.

In the case of a medical search engine, each topic index stores a list of the clinical sites (e.g., web addresses or URLs) relevant to the topic that contain the diagnostic terms. In other words, each of the topic indices associate selected diagnostic terms with the web addresses (e.g., URLs) of selected clinical sites that contain the diagnostic term and are relevant to the topic. For example, the topic index for the topic “Anesthesiology” under the “Clinical” tab might include the diagnostic term “epidural” associated with links to the web addresses for the websites www.americanpregnancy.org and www.spinehealth.org, among others. Specialized search engine 10 searches the topic index associated with the current topic as chosen by the user to find the relevant documents associated with each word in the query.

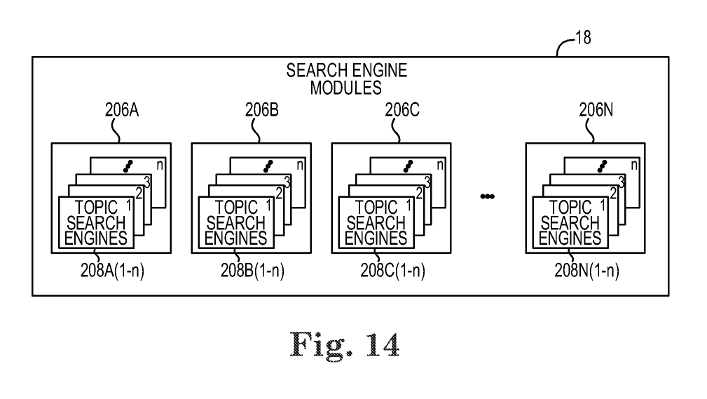

FIG. 14 is a block diagram illustrating an example conceptual arrangement of topic search engine modules 18. Search engine modules 18 include a conceptual arrangement of individual topic search engines arranged in groupings 206A-206N. Each grouping 206A-206N is associated with a different one of theme tabs 106A-106N, respectively. Each grouping 206A-206N includes one or more topic search engines 208A(1-n). For example, in the case of a medical search engine, grouping 206A in FIG. 14 may be associated with the Clinical tab 106A. Topic search engine 208A(1) may be associated with topic “All links-Results” in topic list 108A under the Clinical tab 106A. Topic search engine 208A(2) may be associated with topic “Anesthesiology” in topic list 108A under the Clinical tab 106A, etc.

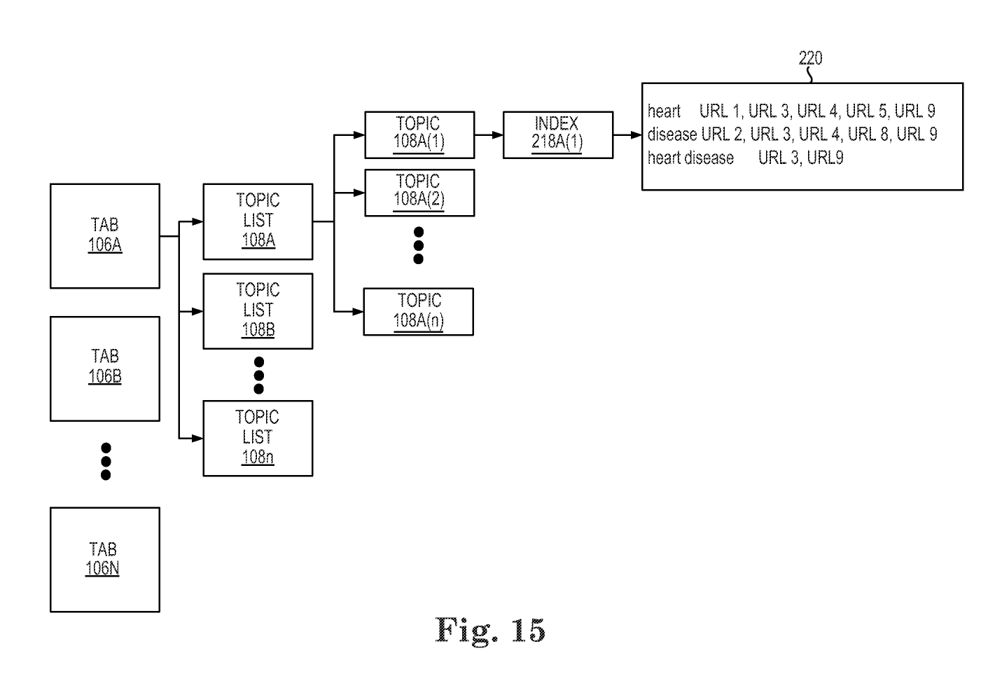

Each of topic search engines has an associated topic index. FIG. 15 is a block diagram illustrating an example conceptual arrangement of topic indexes. The topic indexes are stored in topic databases 50. The tabs 106, topic lists 108, topics and topic indices form a tree-like structure in which topic indices may be thought of as the leaves of the tree. In FIG. 15, each tab 106 is associated with a topic list 108. For example, as described above, tab 106A is associated with a topic list 108A. Topic list 108A includes one or more topics 108A(1-n). Each topic in a topic list 108 is associated with its own topic index 218. In this example, topic 108A(1) is associated with topic index 218A(1).

To help ensure that the specialized search engine returns more results relevant to the subject matter area as compared to a standard, generalized web search engine, the indices may be based, for example, on subject matter terms contained in selected web sites or pages sponsored by respected organizations or entities in that subject matter area rather than on full text indexing of each web document. For example, in the case of a medical search engine, to help ensure that the medical search engine returns more clinically relevant results as compared to a standard, generalized web search engine, the indices are based on diagnostic terms contained in selected web sites or pages sponsored by respected medical organizations or entities rather than on full text indexing of each web document. The indices may largely exclude words that cannot be classified as diagnostic terms.

Each topic index 218 includes an index of relevant subject matter terms and a vetted list of associated web addresses (URLs) containing those subject matter terms. For example, in the case of a medical search engine, each topic index 218 includes an index of relevant diagnostic terms and a vetted list of associated web addresses (URLs) containing those diagnostic terms. The web addresses may be vetted in the sense that not every URL on the web containing the subject matter term (or diagnostic term in the case of a medical search engine) is included in the topic index. Only those URLs that have been independently reviewed by a medical practitioner and determined to be clinically relevant to the topic at issue and that contain the terms in the search query are included in a topic index. As mentioned above, only those URLs sponsored by subject matter organizations (such as respected medical organizations or which have been otherwise determined to contain clinically reliable and up to date medical information in the case of a medical search engine) may be included in the topic indexes. As a result, specialized search engine 10 may return more relevant search results as compared to a standard, generalized web search engine.

An simplified illustration of the contents 220 of an example topic index 218A(1) for a medical search engine is shown in FIG. 15. Topic index 220 includes the diagnostic terms “heart,” “disease” and “heart disease.” Topic index conveys that the diagnostic term “heart” is contained in documents URL 1, URL 3, URL 4, URL 5 and URL 9. The diagnostic term “disease” is contained in documents URL 2, URL 3, URL 4, URL 8 and URL 9. The diagnostic term “heart disease” is contained in documents URL 3 and URL 9. By searching the topic index for terms that match the search query “heart disease,” medical search engine 10 may return documents URL 3 and URL 9 in response to a user entering the search query “heart disease” into search box 102. It shall be understood that topic indices 220 may include those subject matter terms relevant to the subject matter area or area of expertise.

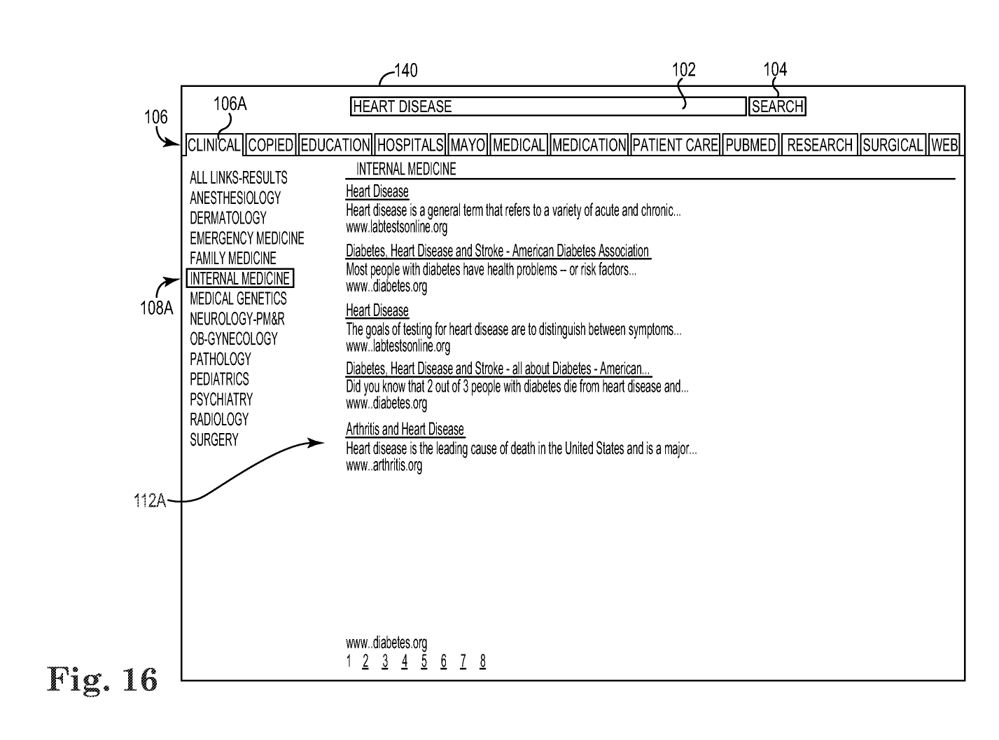

FIGS. 16-24 are diagrams of example user interfaces that may be presented by a medical search engine in response to input by a user. FIG. 16, for example, shows an example user interface 140 which may be displayed when a user has clicked on the Clinical tab 106A and the Internal Medicine topic. In this example, the user has also entered a search query “heart disease” into search box 102 and clicked on search button 104. The medical search engine then performs a search of the Internal Medicine topic index for documents satisfying the search query “heart disease.” Example search results are indicated by reference numeral 112A. It shall be understood that user interfaces for other specialized search engines may include similar functionality to the example medical search engine described herein, and that the disclosure is not limited in this respect.

FIGS. 16-24 illustrate a feature of medical search engine 10 referred to as automatic redirect. When a user clicks on a tab 106 or topic in a topic list 108 from a search results page, medical search engine 10 automatically redirects the search query to the topic search engine associated with the newly chosen topic. The medical search engine thus permits a user to search multiple databases, websites, etc. from a single location without having to individually visit and run the search query on each web site.

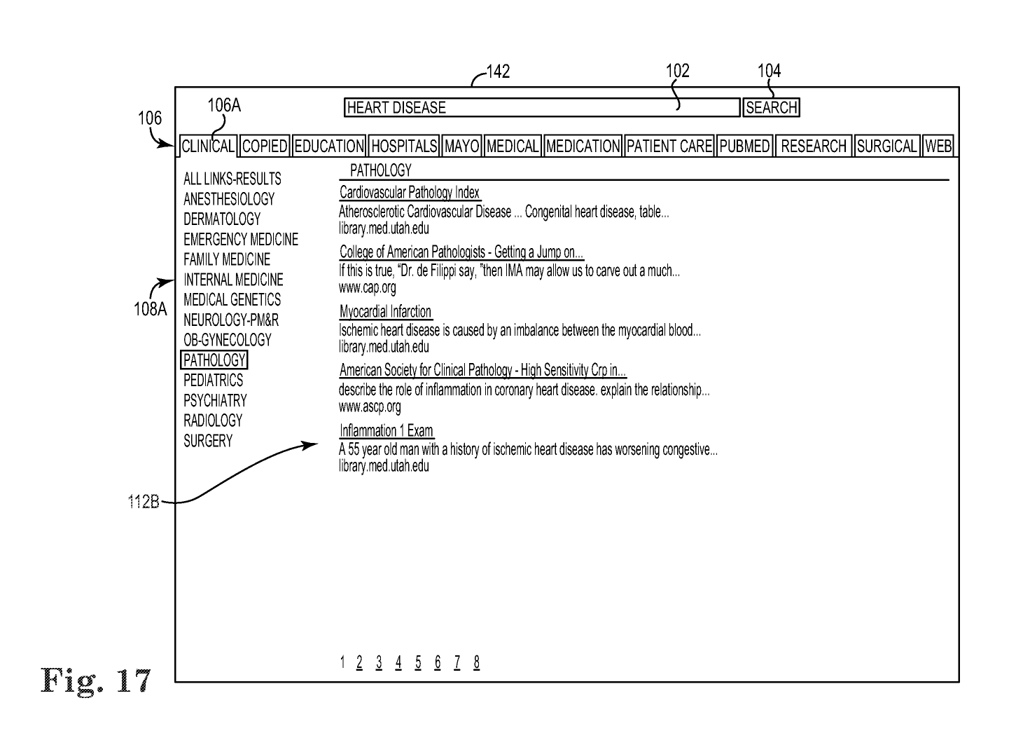

For example, FIG. 17 shows an example user interface 142 which may be arrived at when a user, from user interface 140 of FIG. 16, clicks on the Pathology topic in topic list 108A. Medical search engine 10 automatically redirects the search query “heart disease” to the topic search engine associated with the Pathology topic. In other words, a user clicking on the Pathology topic in topic list 108A automatically causes medical search engine 10 to execute a search of the associated Pathology topic index based on the search query “heart disease.” The automatic redirect occurs without the user first going to the Pathology topic and/or without the user re-entering the search query and without clicking on search button 104. The automatic redirect feature may be implemented using, for example, JavaScript functions or via other appropriate programming languages. The automatic redirect feature permits a user to navigate multiple websites quickly and more efficiently without having to having to visit and search each site independently. It shall be understood that user interfaces for other specialized search engines may include similar functionality to the example medical search engine described herein, and that the disclosure is not limited in this respect.

Example search results of this automatic redirect to the Pathology topic search engine are indicated by reference numeral 112B. Notice that search results 112B are different than search results 112A shown in FIG. 16. This is due to the differences between the topic index associated with the Internal Medicine topic and the topic index associated with the Pathology topic. Because a medical practitioner searching in the Internal Medicine topic would likely have a different type of result in mind than a practitioner searching in the Pathology topic, the topic indices associated with each topic may include different diagnostic terms as well as different URLs linked to those diagnostic terms. The aim is to provide an improved search experience with results that better match the intention of the medical practitioner and provide more clinically relevant search results.

In addition, when a user clicks on, for example, topic All Links-Results in topic list 108A, medical search engine 10 automatically executes a search using each of the topic search engines 208 associated with the associated tab 108. This permits a user to perform multiple searches simultaneously. Each tab 106 includes one such topic in the associated topic list 108 that results in execution of an all topic search based on the current search query. In FIGS. 1-12 and 16-24, for example, the all topic search is executed by clicking on the first topic in topic list 108. However, it shall be understood that the presentation of the tabs, topics, topic lists and search results may be varied and that the disclosure is not limited in this respect. It shall be understood that user interfaces for other specialized search engines may include similar functionality to the example medical search engine described herein, and that the disclosure is not limited in this respect.

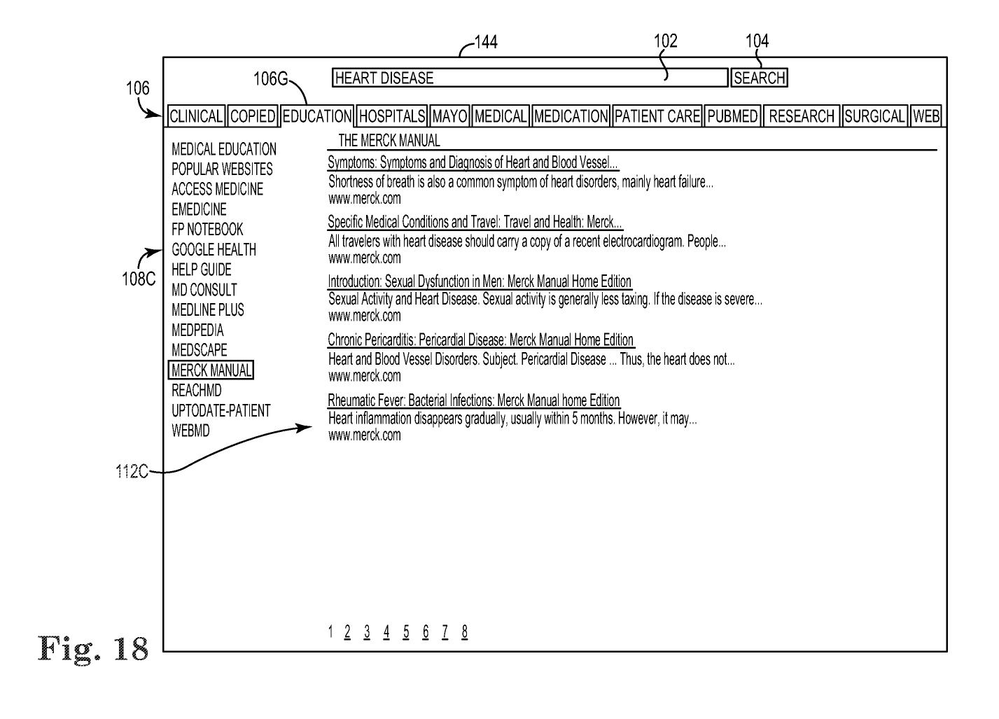

FIGS. 18-24 illustrate further examples of the automatic redirect feature based on the search query “heart disease.” In FIG. 18, a user, while viewing search results 112B of FIG. 17, for example, has clicked on Education tab 106C and topic Merck Manual in topic list 108C. This causes medical search engine 10 to execute a search based on the search query “heart disease” within the topic index associated with the Education topic. Example search results are indicated by reference numeral 112C.

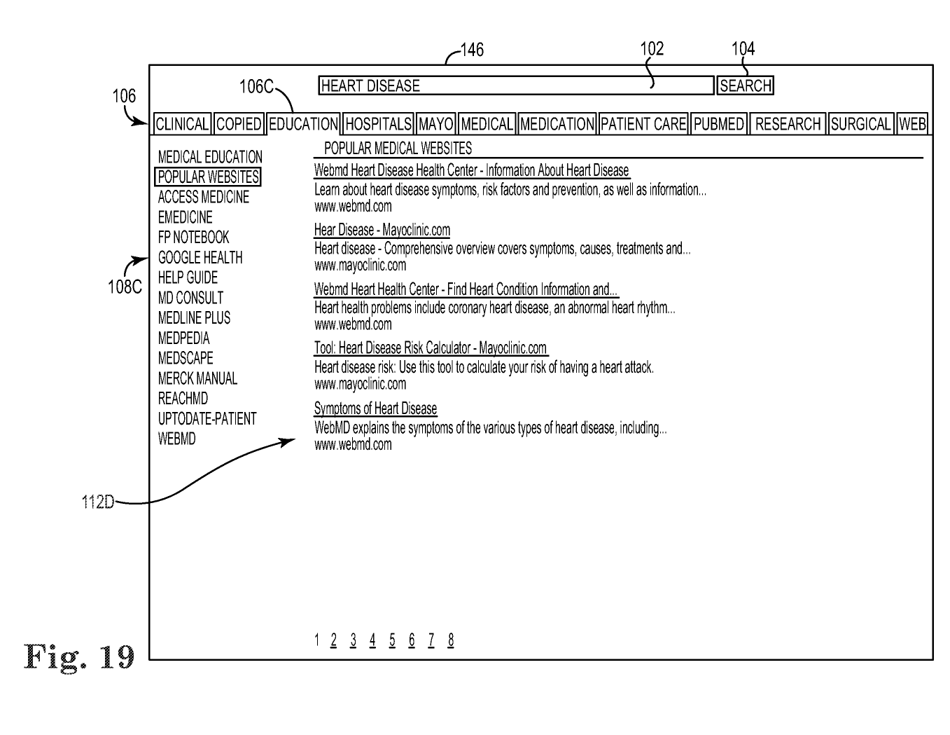

In FIG. 19, a user has clicked on topic Popular Websites in topic list 108C. This causes medical search engine 10 to execute a search based on the search query “heart disease” within the topic index associated with the Popular Websites topic. Example search results are indicated by reference numeral 112D.

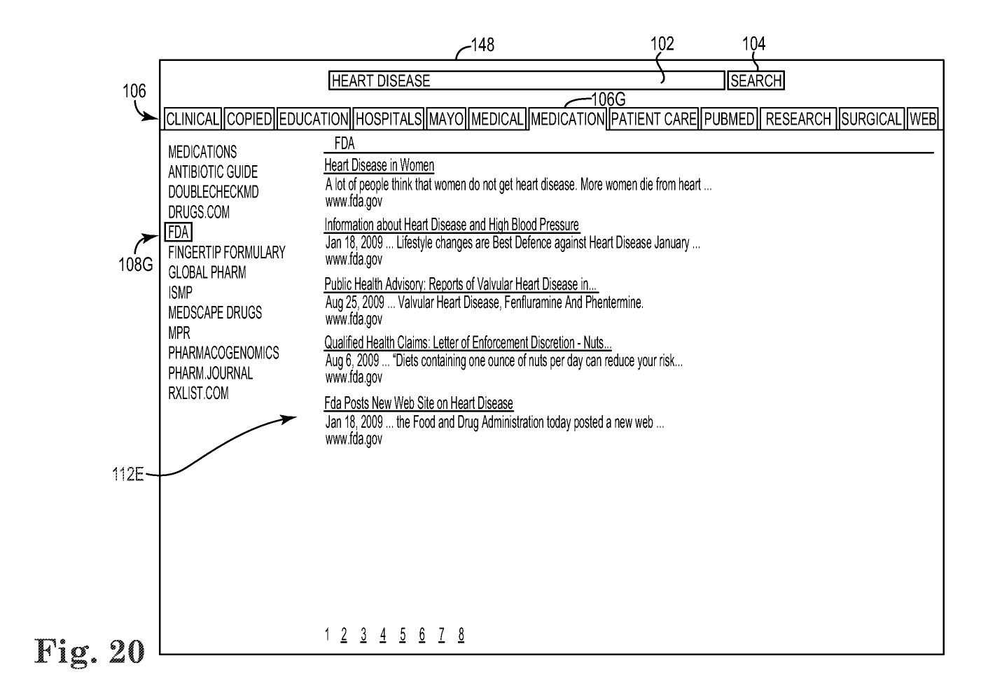

In FIG. 20, a user has clicked on Medication tab 106G and topic FDA in topic list 108G. This causes medical search engine 10 to execute a search based on the search query “heart disease” within the topic index associated with the FDA topic. Example search results are indicated by reference numeral 112E.

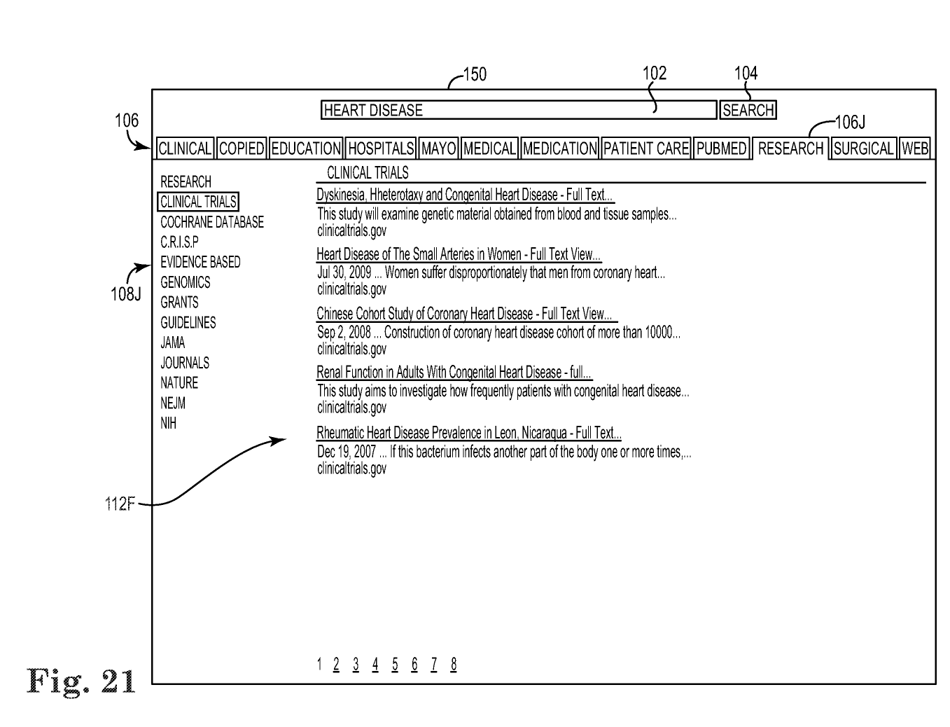

In FIG. 21, a user has clicked on Research tab 106J and topic Clinical Trials in topic list 108J. This causes medical search engine 10 to execute a search based on the search query “heart disease” within the topic index associated with the Clinical Trials topic. Example search results are indicated by reference numeral 112F.

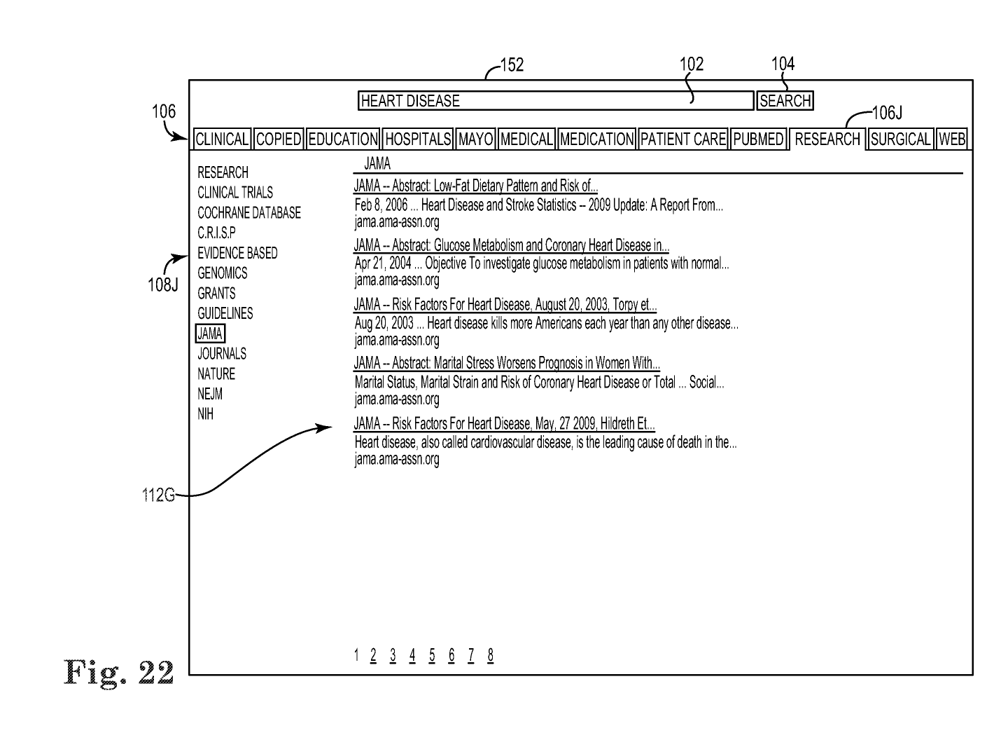

In FIG. 22, a user has clicked on topic JAMA in topic list 108J. This causes medical search engine 10 to execute a search based on the search query “heart disease” within the topic index associated with the JAMA topic. Example search results are indicated by reference numeral 112G.

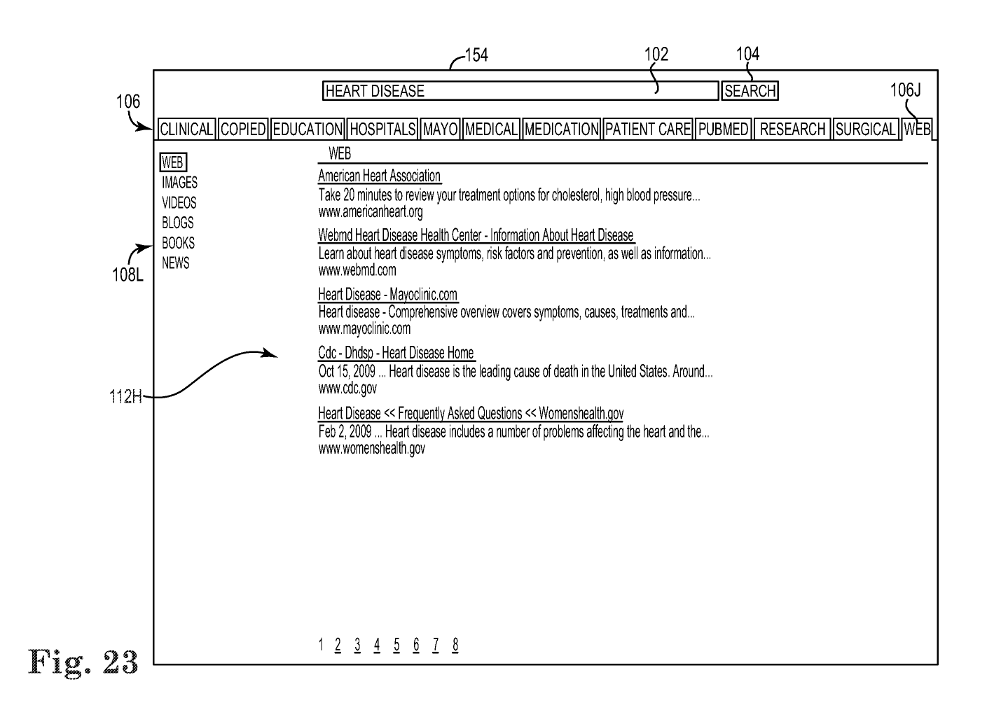

In FIG. 23, a user has clicked on Web tab 106L and topic Web in topic list 108L. This causes medical search engine 10 to execute a search based on the search query “heart disease” within all of the topic indices associated with the Web tab 106L. In this example, medical search engine 10 executes a search based on the search query “heart disease” within the topic indices for the Images topic, the Videos topic, the Blogs topic, the Books topic and the News topic. Example search results are indicated by reference numeral 112H. This is an example of the all topic search described above.

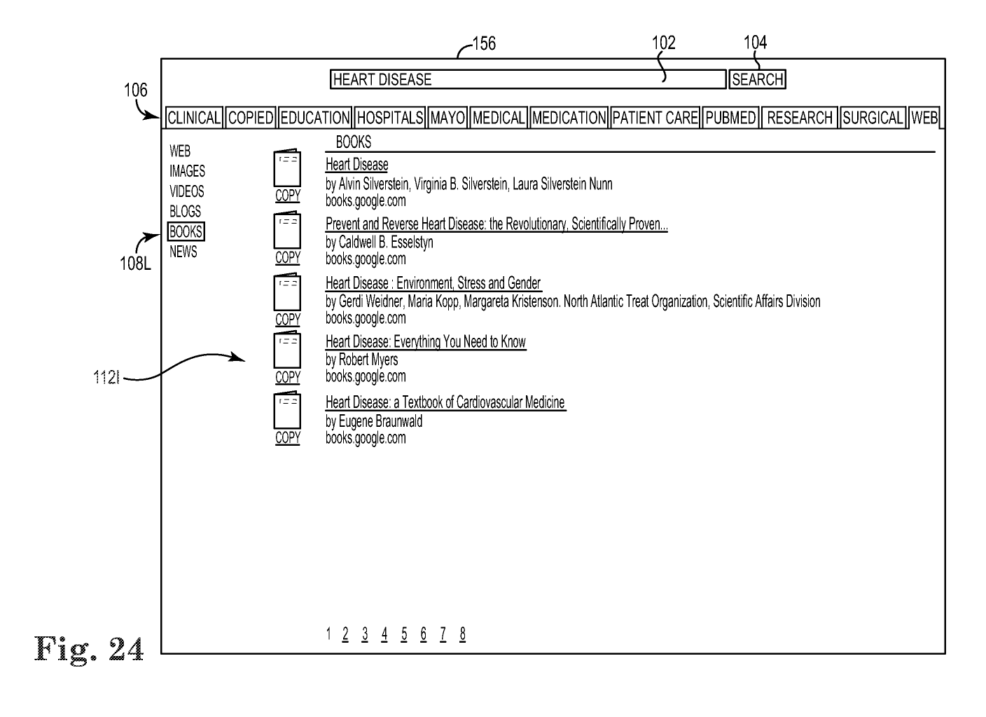

In FIG. 24, a user has clicked on topic Books in topic list 108L. This causes medical search engine 10 to execute a search based on the search query “heart disease” within the topic index associated with the Books topic. Example search results are indicated by reference numeral 1121.

At any time and from any tab/topic, a user may enter a new search query and click on the search button to submit a new search query to medical search engine 10. Once a query has been submitted, the user may navigate through the medical search engine web pages as desired via automatic redirects, e.g., clicking on a new tab or topic.

The techniques described herein with respects to medical search engine 10 may also be used to create specialized search engines for areas of expertise other than medicine. Medical search engine 10 is one example of such a specialized search engine. However, the techniques described herein could be used to create specialized search engines in areas of expertise such as law, business, engineering, electronics, social, popular culture, branches of science, or any other subject matter or area of expertise.

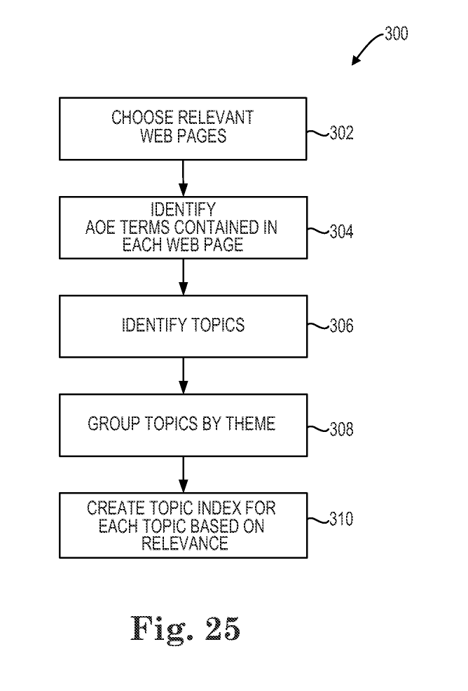

FIG. 25 is a flowchart illustrating an example operational process 300 by which topic indexes for a specialized search engine may be created. One or more subject matter experts in a particular area of expertise (AOE) may choose the relevant web pages for the specialized search engine (302). The specialized search engine will be limited in its search to those web pages chosen by the subject matter expert(s). Alternatively, a programmed computer may automatically identify relevant web pages for a specialized search engine based on parameters relevant to the subject matter area.

In the medical area of expertise, for example, the subject matter expert(s) may include physicians, physician assistants, nurses or other healthcare providers. Chosen web pages for the medical search engine 10 may include, for example, those web pages sponsored by respected medical organizations or entities (such as prominent hospitals, clinics, research facilities, etc.) or which have been otherwise determined by the subject matter expert(s) to contain clinically reputable and up to date medical information.

Clinically relevant diagnostic terms in each web page are identified (304). This could be done either manually or automatically by comparing the web pages with a medical dictionary or other store of diagnostic terms.

The subject matter experts identify topics relevant to the AOE (306). The topics are grouped by theme (308). In the example screen displays shown herein, the themes are displayed as tabs 106 and the topics are displayed in the topic list 108 associated with the theme. The subject matter experts may create a topic index for each identified topic based on relevance to the topic (310). For example, in the case of a medical search engine, the topic index for topic Cardiology in topic list 108F under the Medical tab 106F may include terms such as “coumadin” along with a list of web pages such as circ.ahajournals.org, stroke.ahajournals.org and www.theheart.org.

Some topic indexes may include a link to a web page rather than a list of diagnostic terms and associated web pages. In the case of a medical search engine, such examples may include the topic PubMed under the PubMed tab 106I, the individual hospital topics under the Hospitals tab 106D, or the topics CRISP and JAMA under the Research tab 106J.

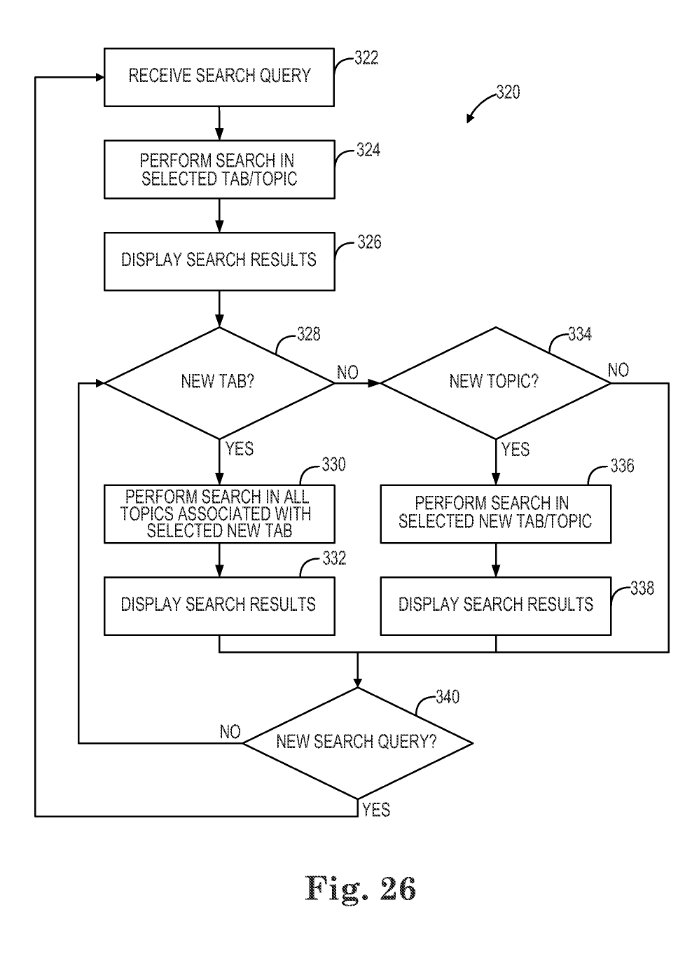

FIG. 26 is a flowchart illustrating an example operational process 320 of medical search engine 10. Process 320 may also be used with specialized search engines in different areas of expertise other than medicine. Specialized search engine receives the search query (322). This is typically instigated when a user enters the search query into search box 102 and clicks search button 104. However, it shall be understood that many other means of entering search queries exist or may be developed in the future and these may also be used. Specialized search engine performs a search based on the search query in the topic index associated with the current tab and topic as selected by the user (324). Specialized search engine returns and displays the search results (326).

If at any time the user selects a new tab (328), specialized search engine automatically redirects the search query to all topic search engines in the topic list associated with the selected new tab (330). Specialized search engine returns and displays the search results (332).

If the user does not select a new tab (328) but does select a new topic from the current topic list (334), specialized search engine automatically redirects the search query to the topic search engine associated with the selected new topic (336). Specialized search engine returns and displays the search results (338).

If the user does not enter a new search query (340) but selects a new tab (328) or topic (334), the process repeats as described above. If the user submits a new search query (340), the specialized search engine receives the search query (322) and repeats the process.

The specialized search engines may also include tags (e.g., xml tags) applied to links that allow the user to enter their user type. In the medical area of expertise, the user types may include, for example, patient, nurse, pharmacist, and doctor. The user type may be entered into the specialized search engine to return search results that are considered more likely to be relevant to that user type. The specialized search engine may also include custom interface designs corresponding to each user type. Therefore, webpage search results would not only pertinent to the user but the layout of the page may be custom designed for the user as well.

The specialized search engine may also include features that permit the user to save and copy search results, post search results to a blog, discuss search results in social media applications, etc.

There are several applications in which the specialized search engines may be used. For example, the medical search engine may be used in applications including but not limited to the following:
a clinical knowledge search application—the user types in a clinical question and uses the search results to find an answer;
a patient education search application—materials can be easily found and printed for assisting with patient education needs, such as commonly occurs when a patient is diagnosed or discharged;
a medication search application—the specialized medical search engine may provide the ability to find useful medication related information instantly and compare the information against several sources for accuracy. This might include dosage, available tab/strength, cost, and side effects, but also includes basic biological information such as mechanism of action and biochemical composition;
a research application—research databases such as C.R.I.S.P, Cochrane, and Pubmed may be simultaneously searched and results can be compared. In addition, several less well known but highly developed databases may be included in a specialized medical search engine, such as the European version of Pubmed. In this example, users don't need to know of the database, and do not have to visit it in order to search it;
further customization—the user interface, appearance, features, functions and/or interactivity of the specialized medial search engine could be further customized for a particular research project or institutional need. For example, a researcher looking at a specific genetic expression could have their own customized search engine designed so that the results would be specific to their purpose. The search tool could be designed so that endless customization may be possible based on user defined input.
librarian-assisted search—librarians often perform clinical and research searches for clinicians and researchers. A specialized search engine may assist such non-medical personnel by limiting their search to clinically relevant sites, which may increase the relevancy of any search results and make it less likely that the search results miss pertinent papers;

Similar example applications may also apply to specialized search engines in other areas of expertise.

The specialized search engines may also be included as part of a social media and/or web 2.0/3.0 application. For example, the specialized search engine may be developed and implemented in a myriad of applications, such as “Facebook” or “Twitter” permitting users to share and discuss results. The specialized search engine may also permit other subject matter experts to contribute to the specialized search engine, thus increasing its base of specialized knowledge in terms of search terms, web pages, etc.

As mentioned above, although the specific example of a specialized medical search engine is described herein, it shall be understood that the specialized search engine techniques may be extrapolated to fields out of medicine; such as law, business, electronics, social and popular culture, and/or any other subject matter area.

The techniques described in this disclosure, including functions performed by a controller, control unit, or control system, may be implemented within one or more of a general purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

The various components illustrated herein may be realized by any suitable combination of hardware, software, firmware. In the figures, various components are depicted as separate units or modules. However, all or several of the various components described with reference to these figures may be integrated into combined units or modules within common hardware, firmware, and/or software. Accordingly, the representation of features as components, units or modules is intended to highlight particular functional features for ease of illustration, and does not necessarily require realization of such features by separate hardware, firmware, or software components. In some cases, various units may be implemented as programmable processes performed by one or more processors or controllers.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices, and may be used in any of a variety of specialized search engines. In some aspects, for example, such components may form part of a specialized search engines, or be coupled functionally to such a specialized search engine.

If implemented in part by software, the techniques may be realized at least in part by a computer-readable data storage medium comprising code with instructions that, when executed by one or more processors or controllers, performs one or more of the methods described in this disclosure. The computer-readable storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASIC's, FPGA's, or other equivalent integrated or discrete logic circuitry.

Various examples have been described. These and other examples are within the scope of the following claims.

1. A method comprising:
choosing web pages relevant to an area of expertise;
identifying search terms relevant to the area of expertise contained in each of the chosen web pages;
identifying a plurality of topics relevant to the area of expertise;
identifying a plurality of themes relevant to the area of expertise;
associating each of the identified topics with one of the identified themes; and
creating topic indexes of identified search terms and associated web pages, each of the web pages associated with a different one of the identified topics, based on relevance of the search terms and the web pages to the topic.

2. The method of claim 1 further comprising:
receiving input from a user via a remote device that identifies a first one of the themes and a first one of the topics in which a search is to be performed;
receiving a search query from the user via the remote device;
generating a first set of search results for the search query based on the topic index associated with the first topic; and
transmitting search results to the remote device.

3. The method of claim 2 further comprising displaying the search results at the remote device.

4. The method of claim 1 further comprising:
receiving input from the user via the remote device that identifies a second one of the topics in which a search is to be performed; and
generating a second set of search results for the search query based on the topic index associated with the second topic.

5. The method of claim 1 further comprising:
receiving input from the user via the remote device that identifies a second one of the themes in which a search is to be performed; and
generating a second set of search results for the search query based on the topic indexes associated with each of the topics associated with the second theme.

6. The method of claim 1 further comprising:
choosing web pages relevant to a medical area of expertise;
identifying search terms relevant to the medical area of expertise contained in each of the chosen web pages;
identifying a plurality of topics relevant to the medical area of expertise;
identifying a plurality of themes relevant to the medical area of expertise;
associating each of the identified topics with one of the identified themes; and
creating topic indexes of identified search terms and associated web pages, each associated with a different one of the identified topics, based on relevance of the search terms and the web pages to the topic.

7. A system, comprising:
at least one topic database that stores a plurality of topic indexes each associated with one of plurality of topics relevant to an area of expertise, each topic index including a plurality of search terms and associated lists of web pages relevant to the area of expertise and relevant to the topic that contain the search terms; and
a processor configured to receive input from a user via a remote device that identifies one of the plurality of topics in which a search is to be performed, receive a search query from the user via the remote device, and generate a set of search results for the search query based on the topic index associated with the identified topic.

8. The system of claim 7 wherein the processor is further configured to transmit the search results to the remote device.

9. The system of claim 7 wherein the processor is further configured to receive input from the user via the remote device that identifies a second one of the topics in which a search is to be performed, and generate a second set of search results for the search query based on the topic index associated with the second topic.

10. The system of claim 7 wherein the processor is further configured to receive input from the user via the remote device that identifies a second one of the themes in which a search is to be performed, and generate a second set of search results for the search query based on the topic indexes associated with each of the topics associated with the second theme.

11. The system of claim 7 wherein the search terms are identified as relevant to the area of expertise by a subject matter expert.

12. The system of claim 7 wherein the web pages are identified as relevant to the area of expertise by a subject matter expert.

13. The system of claim 7 wherein the area of expertise is the practice of medicine.

14. A computer-implemented method comprising:
receiving input from a user via a remote device that identifies one of a plurality of topics associated with one of a plurality of themes relevant to a subject matter area in which a search is to be performed;
receiving a search query from the user via the remote device;
generating a set of search results for the search query based on a topic index of identified search terms and associated web pages associated with the one of the plurality of topics; and
transmitting search results to the remote device.

15. The computer-implemented method of claim 14, further including creating the topic index based on relevance of the identified search terms and the web pages to the topic.

16. The computer-implemented method of claim 15, further including displaying the search results at the remote device.

17. The computer-implemented method of claim 14 further comprising:
receiving input from the user via the remote device that identifies a second one of the plurality of topics in which a search is to be performed; and
generating a second set of search results for the search query based on the topic index associated with the second topic.

18. The computer-implemented method of claim 14 further comprising:
receiving input from the user via the remote device that identifies a second one of the plurality of themes in which a search is to be performed; and
generating a second set of search results for the search query based on the topic indexes associated with each of the topics associated with the second theme.

19. The computer-implemented method of claim 14 further comprising receiving a plurality of identified search terms and associated web pages relevant to the practice of medicine.
